(19) United States
(12) Patent Application Publication
(10) Pub. No.: US 2020/0380501 A1
(43) Pub. Date: Dec. 3, 2020

(54) SYSTEMS AND METHODS FOR FACILITATING A PAYMENT USING A PAYMENT CODE

(71) Applicant: Wells Fargo Bank, N.A., San Francisco, CA (US)

(72) Inventors: Ramanathan Ramanathan, Bellevue, WA (US); Andrew J. Garner, IV, State Road, NC (US)

(21) Appl. No.: 14/794,229

(22) Filed: Jul. 8, 2015

(51) Int. Cl. G06Q 20/38; G06Q 20/32

(52) U.S. Cl. CPC G06Q 20/385; G06Q 20/322

(57) ABSTRACT

A computer-implemented method performed by one or more processors of a payer financial institution computer system includes receiving, by the payer financial institution computer system, a request from a computing device of a payer to make a payment to a payee from a payment account held by the payer and provided by the payer financial institution computer system, wherein the request includes a passkey and a payment amount, generating, by the payer financial institution computer system, a unique payment code based on the request, including embedding the passkey within the unique payment code, wherein the unique payment code is redeemable by the payee to access the payment amount upon providing the passkey, and sending, by the payer financial institution computer system, the unique payment code to the payer device.

### BACKGROUND

Funds are often required to be transferred from a payer (i.e., a person, entity, etc.) to a payee (i.e., another person, another entity, etc.). However, existing methods for transferring the funds from the payer to the payee may be overcomplicated or burdensome. The funds may be transferred, for instance, by cash, but cash is not prevalent and may only be practical for transferring smaller sums. The funds may also be transferred by check, money order, automated clearing house (“ACH”) transfer, wire transfer, cashier's check, and the like, but each of these methods may require additional processing time before the funds are made available to the payee. These methods may also incur fees charged to one or both of the parties (e.g., by intervening payment processors, acquirers, etc.) as part of the transaction. Even more recent Internet-based peer-to-peer payment methods may require a central agency where both parties have an account or a pre-established agreement with a common service provider. Further, these methods may not provide a secure method for transferring the funds.

### SUMMARY

One embodiment of the present disclosure relates to a computer-implemented method performed by one or more processors of a payer financial institution computer system. The method includes receiving, by the payer financial institution computer system, a request from a computing device of a payer to make a payment to a payee from a payment account held by the payer and provided by the payer financial institution computer system, wherein the request includes a passkey and a payment amount, generating, by the payer financial institution computer system, a unique payment code based on the request, including embedding the passkey within the unique payment code, wherein the unique payment code is redeemable by the payee to access the payment amount upon providing the passkey, and sending, by the payer financial institution computer system, the unique payment code to the payer device.

Another embodiment of the present disclosure relates to a computer-implemented method performed by one or more processors of a payer financial institution computer system. The method includes receiving, by the payer financial institution computer system, a request from a computing device of a payer to make a payment to a payee from a payment account held by the payer and provided by the payer financial institution computer system, wherein the request includes a payment amount, a first passkey, and a second passkey, and wherein the first passkey is an alphanumeric phrase provided by the payee and the second passkey is a unique identifier for the payee, generating, by the payer financial institution computer system, a unique payment code based on the request, including embedding the first passkey and the second passkey within the unique payment code, wherein the unique payment code is redeemable by the payee to access the payment amount upon providing the first passkey and the second passkey, and sending, by the payer financial institution computer system, the unique payment code to the payer device.

Another embodiment of the present disclosure relates to a computer-implemented method performed by one or more processors of a payer financial institution computer system. The method includes receiving, by the payer financial institution computer system, a request from a computing device of a payer to make a payment to a payee from a payment account held by a payer and provided by the payer financial institution computer system, wherein the request includes a passkey, a payment amount, and a required recipient, generating, by the payer financial institution computer system, a unique payment code based on the request, including embedding the passkey within the unique payment code, wherein the unique payment code is redeemable by the payee to access the payment amount only at the required recipient, and only upon providing the passkey to the required recipient, and sending, by the payer financial institution computer system, the unique payment code to the payer device.

Another embodiment of the present disclosure relates to a mobile device that includes a processor coupled to machine readable storage media having instructions stored therein that, when executed by the processor, cause the processor to send a request to a payer financial institution computer system to make a payment to a payee from a payment account held by a user of the mobile device and provided by the payer financial institution computer system, wherein the request includes a passkey and a payment amount, receive a unique payment code from the payer financial institution computer system based on the request, wherein the unique payment code is redeemable by the payee to access the payment amount upon providing the passkey, and wherein the passkey is embedded within the unique payment code, and store the unique payment code.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a schematic diagram of a payment processing system, according to an example embodiment.

FIG. 2 is a schematic flow diagram of a process that may be implemented using the system shown in FIG. 1, the process including facilitating a payment from a payer to a payee, according to an example embodiment.

FIG. 3 is a user interface that may be presented on the display of a payer computing device as shown in FIG. 1, according to an example embodiment.

FIG. 4 is a schematic flow diagram of another process that may be implemented using the system shown in FIG. 1, the process including facilitating a payment from a payer to a payee using a payment code having an embedded passkey, according to an example embodiment.

FIG. 5 is a schematic flow diagram of another process that may be implemented using the system shown in FIG. 1, the process including facilitating an electronic gift card payment from a payer to a payee using a payment code, according to an example embodiment.

FIG. 6 is a schematic flow diagram of another process that may be implemented using the system shown in FIG. 1, the process including facilitating a payment from a payer to a payee using a payment code having enhanced verification, according to an example embodiment.

FIG. 7 is a schematic flow diagram of another process that may be implemented using the system shown in FIG. 1, the process including facilitating a payment from a payer to a payee using a payment message having a unique payment code, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

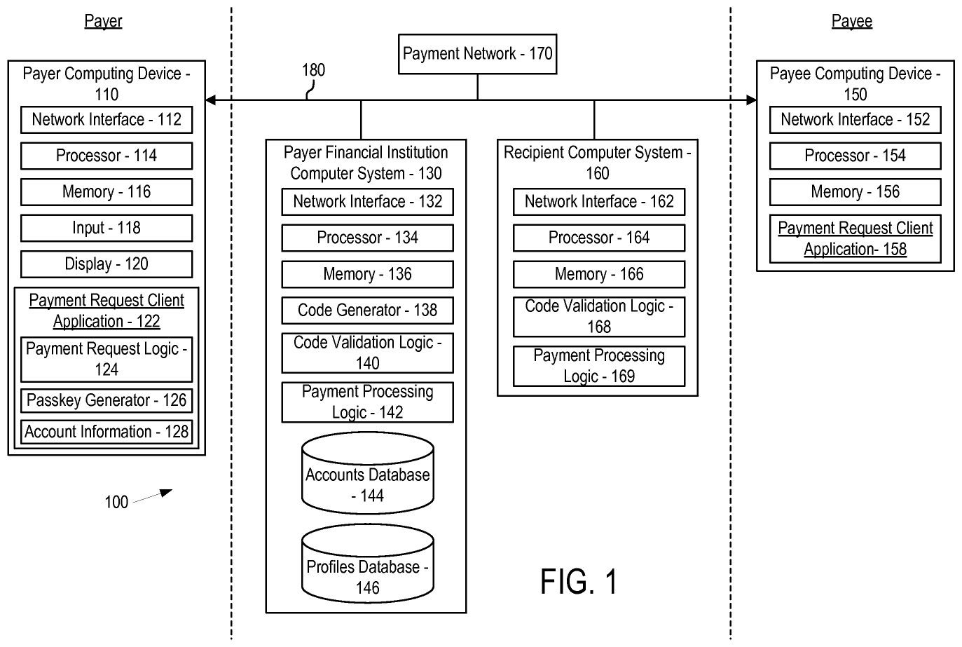

Referring to FIG. 1, a computer-implemented payment processing system 100 is shown, according to an example embodiment. The payment processing system 100 enables a payer (i.e., an account holder) to transfer money to a payee from a financial account held by the payer. The payer and the payee may be individuals, business or other entities, and/or representative computer systems. The financial account may include a business or consumer demand deposit account, credit card account, debit card account, other line of credit, or any other payment form (e.g., gift cards, stored value cards, etc.) from which money may be transferred. The financial account may be provided (e.g., issued, managed, etc.) by a financial institution (i.e., a payer financial institution), which may refer to any entity that is able to process a payment transaction on behalf of the payer, including a depositary financial institution (e.g., a bank or credit union), a credit provider (e.g., a credit card company, a merchant, etc.), or any other payment provider (e.g., an acquirer, a payment processor, etc.).

In an example embodiment, the payment processing system 100 facilitates generation of a payment code that may be provided to the payee as a form of payment. The payment code is generated based on a request received from the payer. As part of the request, the payer provides information related to the payment, including payment account information, a payment amount, and a passkey. The payment code is then generated based on the provided information, including the passkey. The payment code may then be provided to the payer (i.e., the requesting party), or sent directly to the payee. Once the payee receives the payment code, the payee may access the associated funds by presenting the payment code to a recipient (i.e., a recipient computer system). The recipient may validate the payment code and/or the payee prior to processing the payment, which may include receiving the passkey from the payee. Once the payment code and/or the payee are validated, the payment amount is transferred to the payee from the payment account of the payer.

It should be noted that although the funds transfer facilitated by the payment processing system 100 is referred to as a payment in various embodiments herein, use of the term payment is not intended to be limiting, and should be interpreted as referring to any transfer of value from a payer to a payee, including a gift. Further, while the payer and the payee are referred to herein as individual persons, in various embodiments the payment processing system 100 may also be used to facilitate payments to or from a business or other entity.

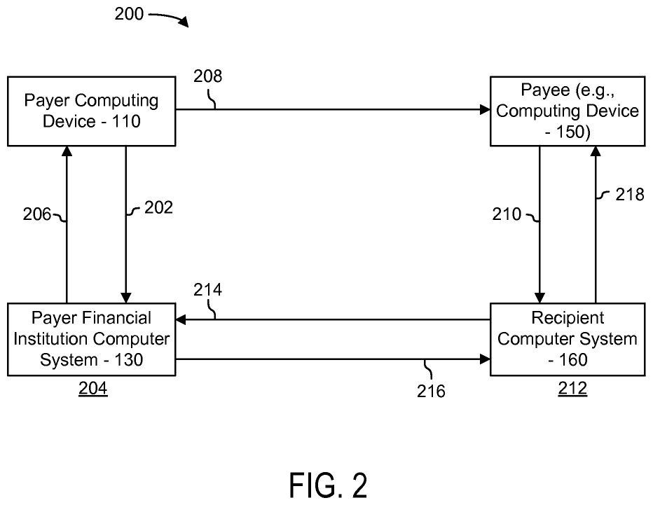

Referring still to FIG. 1, the payment processing system 100 may include, among other systems, a payer computing device 110, a payer financial institution computer system 130, a payee computing device 150, a recipient computer system 160, and a payment system 170 (e.g., a credit card network). The systems and devices may each be owned and operated by a separate entity. In other embodiments, two or more of the systems and devices shown in FIG. 1 may be owned and/or operated by a single entity, including having two or more of the systems and devices being combined to operate as a single system. Each of the systems and devices may include a computer system (e.g., one or more servers each with one or more processing circuits) configured to execute instructions, send and receive data stored in memory, and perform other operations to implement the logic or processes shown in FIGS. 2 through 7.

The payer computing device 110, the payer financial institution computer system 130, the payee computing device 150, the recipient computer system 160, and the payment system 170 may each include processor(s) and memory. The one or more processors may be implemented as application specific integrated circuits (ASICs), one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and non-transitory computer storage media. The memory may include data base components, object code components, script components, or any other type of information structure for supporting the various activities and information structures described herein. The memory may be communicably connected to the processor(s) and include computer code or instructions for executing one or more processes described herein.

The payer computing device 110, the payer financial institution computer system 130, the payee computing device 150, the recipient computer system 160, and the payment system 170 may communicate through a network 180. The network 190 may be a single communication network configured to communicatively connect each of the systems, or the network 190 may include a plurality of networks each connecting two or more systems. The network 190 may include a wired or wireless network, including one or more of the Internet, a cellular network, Wi-Fi, Wi-Max, a proprietary banking network, and so on.

Referring still to FIG. 1, the payer computing device 110 is utilized by the payer (i.e., a user of the payment processing system 100) to communicate with one or more of the other systems and devices. The payer computing device 110 may be a mobile device such as a handheld computer, a cellular phone, smartphone, mobile handheld wireless e-mail device, a tablet computer, personal digital assistant, portable gaming device, or another suitable device. The payer computing device 110 may also include another type of computing device configured to access the network 180 or otherwise communicate with at least the payer financial institution computer system 130, including a desktop or laptop computer executing browser software to perform the operations described herein.

The payer computing device 110 includes a network interface 112, processor 114, memory 116, input 118, display 120, and payment request client application 122. The network interface 112 may be a wireless network interface that communicates with a wireless communication protocol (e.g., 802.11a/b/g/n, Bluetooth®, ZigBee®, CDMA, GSM, LTE, WiMax, etc.). The network interface 112 may include, for example, program logic that connects the payer computing device 110 to the network 180. The network interface 112 may be utilized by the payer computing device 110 to communicate with the other systems and devices of the payment processing system 100, including to send a payment request and receive the payment code from the financial institution computer system 130. For instance, the payer computing device 110 may receive and display a screen (e.g., user interface 300) intended to prompt the payer to provide payment information. Such a screen may be presented to the payer via the display 120. The input 118 (e.g., keyboard, touchscreen, etc.) may be utilized by the payer to provide the requested information. In some arrangements, the display 120 and the input 118 are integrated in a touchscreen display.

The memory 116 includes programming modules and logic that, when executed by the processor 114, control the operation of the payer computing device 110. For instance, the payment request client application 122 may be stored on memory 116. The payment request client application 122 may comprise program logic executable by the payer computing device 110 to implement at least some of the functions described herein. The payment request client application 122 may refer to any application or web interface provided to the payer via the payer computing device 110. The payment request client application 122 may also include any other communications terminal configured to enable electronic communication between the payer and the other systems and devices of system 100.

The payment request client application 122 may be provided by a financial institution of the payer (i.e., the financial institution computer system 130). As will be appreciated, the level of functionality that resides on the payer computing device 110 as opposed to the financial institution computer system 130 may vary depending on the implementation. In one embodiment, the payment request client application 122 may be (or be included as part of) a mobile wallet application configured to allow the user to make payments from accounts provided by the financial institution computer system 130 using the payer computing device 110 (e.g., a mobile device). In this embodiment, the payer may be able to communicate with the financial institution computer system 130 as described herein by accessing a payment request portion of the mobile wallet application.

In the illustrated embodiment of FIG. 1, the payment request client application 122 includes payment request logic 124 and a passkey generator 126. The payment request logic 124 may be executed to perform various functions of the payment request client application 122, including any of the operations described herein and attributed to the payer computing device 110. The payment request logic 124 is configured to enable the payer to request a payment code from the payer financial institution computer system 130. For instance, the payment request logic 124 may prompt the payer to provide any information that is required as part of the payment request, including payment account information, a payment amount, and a passkey. The payment request logic 124 may also provide the payment code to the payer once the payment code is generated by the payer financial institution computer system 130. The payment code is intended to be redeemable by the payee to receive the payment amount.

The passkey generator 126 may be executed to generate the passkey. The passkey may be randomly generated. The passkey may be alphanumeric, including an alphanumeric phrase or password. The passkey may be generated based on the payer, the payee, and/or the payment. The passkey is intended to be embedded within, or otherwise associated with, the payment code. The passkey may then be used to validate the payment code and/or the payee prior to transferring the payment amount to the payee (or otherwise redeeming the payment code). In other embodiments, the passkey may be provided by the payee.

The payment request client application 122 also includes account information 128. The account information 128 stores associations between the payer and any accounts of the payer that may be maintained by or otherwise associated with the payer financial institution computer system 130. The account information 128 is periodically updated based on information received from the payer financial institution computer system 130 (e.g., every minute, every ten minutes, every time the user logs into the payment request client application 122, etc.). The account information 128 may also contacts of the payer, including identifying information for any payees. The contact book or listing includes information relating to other mobile wallet users associated with the payer. The contact book or listing may pull contact information from the payer financial institution computer system 130 or another contact database stored in the memory 116.

Still referring to FIG. 1, the payer financial institution computer system 130 is operated by a payer financial institution, which may refer to any entity that is able to process a payment transaction on behalf of the payer. The payer financial institution computer system 130 may provide one or more payment accounts (i.e., accounts from which value can be transferred by the payer) that are held by the payer. As described in further detail below, the payer financial institution computer system 130 is configured to process payments to a payee from the one or more payment accounts of the payer. The financial institution computer system 130 includes a network interface 132 that enables the financial institution computer system 130 to communicate data to and from the other devices and systems described herein via the network 180. The network interface 132 may include, for example, program logic that connects the financial institution computer system 132 to the network 180.

The payer financial institution computer system 130 also includes a processor 134 and memory 136. The memory 136 stores programming modules that, when executed by the processor 134, control the operation of the financial institution computer system 130. For instance, the payer financial institution computer system 130 includes a code generator 138, code validation logic 140, and payment processing logic 142. Such logic may be implemented in a machine (e.g., one or more networked computer servers) comprising machine-readable media (e.g., memory 136) having instructions stored therein which are executed by the machine to perform the operations described herein.

The code generator 138 may be executed to generate the payment code. The payment code is intended to be redeemable by a payee to receive a payment from a payer. The payment code is generated based on a request from the payer to make a payment (i.e., a payment request). The payment request may include information related to the payment, including payment account information, payee information, a payment amount, and a passkey. The payment request may also include a specified life (e.g., expiration date) for the payment code, and a specified recipient at which the payment code may be redeemed (e.g., the recipient computer system 160). The code generator 138 may be configured to generate the payment code based on the payment information. In an example embodiment, the code generator 138 is configured to store (e.g., embed, associate) the passkey within the generated payment code. The stored passkey may then be used to validate the payment code and/or the payee when the payment code is redeemed. In various embodiments, the code generator 138 may also embed any other information provided with the payment request, including images, sounds, and other files. The code generator 138 may also embed identifying information for the payer financial institution computer system 130, so that any redeeming entity may contact the payer financial institution computer system 130 to validate the payment code.

The payment code may be a graphic code (e.g., a barcode, a two-dimensional barcode, a quick response (“QR”) code, etc.) that is displayable on the payee computing device 150. The graphic code may be scannable by the recipient computer system (e.g., a POS device) in order to redeem (e.g., read, validate) the payment code. The payment code may also be an alphanumeric code (e.g., a 16-digit card number) that is redeemable by the payee to access (e.g., receive, transfer) funds associated with the payment. The payment codes generated by the code generator 138 may be similar to, and generated in much the same way, as those payment codes (e.g., tokens) described in U.S. application Ser. No. 14/266,556, entitled “Mobile Wallet Systems and Trace Identifier,”, the entirety of which is hereby incorporated. Once the payment code is generated, the code generator 138 may provide the generated payment code to the payer (e.g., via the payment request client application 122). The payment code may be provided via the payment request client application 122, or otherwise communicated to the payer (e.g., by email, text message, etc.).

The code validation logic 140 may be executed to validate the payee (and/or the payment code) when the payment code is presented for redemption. The payment code is validated by the code validation logic 140 based on the passkey and any other verification information stored within the payment code. For instance, the payee may attempt to deposit the payment amount by presenting the payment code to the payee's financial institution (i.e., recipient computer system 160). The payee's financial institution may then send the payment code to the payer financial institution computer system 130 for validation. When the payment code is received, the code validation logic 140 may request any information required to validate the payee, including the passkey. The code validation logic 130 validates the payee and/or the payment code by matching any verification information received from the payee (e.g., via the recipient computer system 160) to the same information stored within the payment code. For instance, the recipient computer system 160 may be configured to de-tokenize, or decode, the payment code to reveal the passkey and any other verification information. Once the payee is validated, the funds associated with the payment code may be released by the payer financial institution computer system 130. In other embodiments, the payment code may be validated directly by the recipient computer system 160, as is described below.

The payment processing logic 142 may be executed to process the payment from the payment account of the payer to the payee. For instance, the payment processing logic 142 may move the funds (i.e., the payment amount) from the payment account of the payer to an account specified by the recipient computer system 160 when the payee and/or the payment code is validated. The payment processing logic 142 may also be configured to hold the funds associated with the payment (i.e., the payment amount) until the full payment amount (or an equivalent value) is received by the payee. In one embodiment, the payer financial institution computer system 130 may prevent access to the payment amount by the payer after the payment request is made, guaranteeing that the associated funds are available when the payee redeems the payment code. In another embodiment, the payer financial institution computer system 130 removes the payment amount from the payment account of the payer and stores within a temporary account until the payee redeems the payment code.

The payer financial institution computer system 130 maintains various information related to customer accounts in an accounts database 144. In some arrangements, the accounts database 144 is split into multiple accounts databases. The accounts database 144 is where the payer financial institution computer system 130 stores information relating to financial accounts held with the payer bank, including account balance information and account ownership information. The payer financial institution computer system 130 further includes a mobile wallet profiles database 146. The mobile wallet profiles database 146 maintains a database of mobile wallet users and associations of the mobile wallet users with various accounts in the accounts database 144 (e g , linking a user's mobile wallet to the user's checking account with the payer bank).

Still referring to FIG. 1, the payee computing device 150 may be utilized by the payee to communicate with one or more of the other systems and devices of the payment processing system 100. For instance, the payee computing device 150 may be configured to communicate payment information, including the payment code, with the payer computing device 110 via the network 180. The payee may be a user of the payment processing system 100. The payee may hold an account provided by the payer financial institution computer system 130. The payee computing device 150 may be similar to the payer computing device 110. For instance, the payee computing device 150 may be a mobile device or another type of computing device described above in reference to the payer computing device 110. The payee computing device 150 also includes a network interface 152, processor 154, and memory 156. Any description herein referring to the payer computing device 110 may be similarly applied to the payee computing device 150, including any references to similarly named components.

The payee computing device 150 also includes a payment request client application 158, which may be similar to the client application 122. The payee computing device 150 may utilize the payment request client application 158 to send payment information to the payer, to receive a payment code from the payer, and to redeem the payment code at the recipient computer system 160. For instance, the payment code may be stored and displayed using the payment request client application 158. The payment request client application 158 may also be utilized to generate a passkey. The payment request client application 158 may be provided by the payer financial institution computer system 130.

Still referring to FIG. 1, the recipient computer system 160 is operated by a recipient of the payment code. The recipient computer system 160 is configured to provide value to the payee in exchange for the payment code. The recipient computer system 160 may be or include a point of sale (POS) device or other computer system held by a merchant or a payee bank associated with the payment processing system 100. The recipient computer system 160 includes a network interface 162. The network interface 162 may enable the recipient computer system 160 to communicate with the other systems and devices of the payment processing system 100 via the network 180. The recipient computer system 160 also includes a processor 164 and memory 166. The memory 166 stores programming modules and logic that, when executed by the processor 164, control the operation of the recipient computer system 160. For instance, the recipient computer system 160 includes code validation logic 168 that may be executed to validate the payee and/or the payment code when the payment code is presented for redemption. The code validation logic 168 may be similar to code validation logic 140, and may perform any of the operations described herein as being attributed to the code validation logic 140.

The recipient computer system 160 also includes payment processing logic 169 that may be executed to process a payment, including providing the payment amount to the payee. Once the payee and/or the payment code are validated, the payment processing logic 169 is configured to receive the funds from the payer (e.g., the payer financial institution computer system 130) and transfer the funds (or an equivalent value) to the payee. In some embodiments, the recipient computer system 160 is operated by a financial institution. In these embodiments, the payee may redeem the payment code at the recipient computer system 160 in exchange for the payment amount. For instance, the recipient computer system 160 may deposit the payment amount in an account of the payee, provide cash to the payee, or provide a value card In other embodiments, the recipient computer system 160 is operated by a merchant. In these embodiments, the payee may redeem the payment code at the recipient computer system 160 in exchange for goods and/or services (i.e., as a form of payment to the merchant). For instance, the recipient computer system 160 may provide an equivalent amount of goods and/or services to the payee in exchange for the payment code.

Referring now to FIG. 2, a process 200 is shown for processing a payment from the payer to the payee using a payment code, according to an example embodiment. The process 200 may be performed using the payment processing system 100 shown in FIG. 1. The process 200 may be used to transfer funds and other value to the payee from a payment account held by the payer.

At 202 of the process 200, the payer financial institution computer system 130 receives a payment request (i.e., a request for a payment code) from the payer computing device 110. The payment request includes information related to the requested payment. In an example embodiment, the payment request includes at least a selection of a payment account, a payment amount, and a passkey. In various embodiments, the payment request may also include other payment information, including a timestamp (e.g., for the payment code request), a type of payment (e.g., currency), details related to the payer and/or the payee, a life cycle of the payment code (e.g., expiration date), a location of the payee and/or the payer, a specified redemption location, and details related to the authentication policy of the payment code. Any information provided with the payment request may be stored (e.g., embedded) with the payment code when generated and used to validate the payee upon redemption of the payment code. The payer financial institution computer system 130 may specify any information that is required to generate a payment code (i.e., to submit a payment request). For instance, additional security information may be required for payments having a higher value. As an example, the payer financial institution computer system 130 may require additional or more private information for payment amounts over a certain threshold in order to ensure a more secure payment.

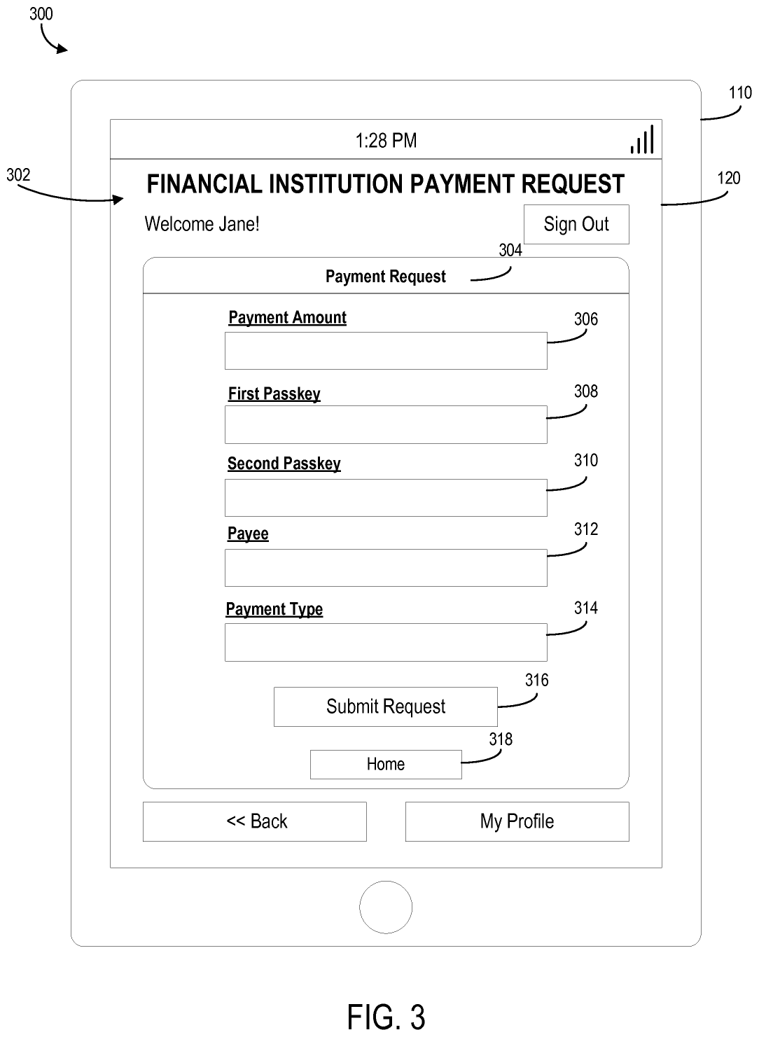

The payment request may be received from the payer computing device 110 via the payment request client application 122, or another web interface provided by the payer financial institution computer system 130. For example, FIG. 3 shows a user interface 300 that may be presented to the payer on the display 120 of the payer computing device 110 when the payer is accessing a website 302 of the payer bank, such as via the payment request client application 122 or a web browser of the payer computing device 110. The user can access a payment request area 304 and submit various information required to submit a payment request. For instance, the payer may submit a payment amount by interacting the text box 306, a first passkey by interacting with text box 308, a second passkey by interacting with text box 310, a payee by interacting with text box 312, and a payment type (e.g., a payment account) by interacting with text box 314. When the user interacts with button 316, the payment code request is submitted. When the user interacts with button 318, the user is taken to the home page of the financial institution website (or an associated application of the financial institution). Although the various fields require a text input in this embodiment, in other embodiments the user interface 300 may include dropdown menus showing popular or frequently used selections. Further, the user may be able to specify further security information (e.g., additional passkeys) to be embedded within the payment code in other embodiments.

In some embodiments, the passkey (and any other verification information) may be provided to the payer by the payee. For instance, the payee may send a passkey to the payer computing device 110 (e.g., via the payee computing device 150) to initiate a payment from the payer to the payee. The passkey may then be sent to the payer computing device 110 as part of the payment request. In these embodiments, the passkey may be a unique identifier that represents the payee. For instance, the passkey may include a phrase provided by the payee, a driver's license number of the payee, a copy of the payee's driver's license, an image of the payee, biometric data related to the payee, or any combination of the above. The passkey may also be unique to the payment, which may include being randomly generated. For instance, the payee computing device 150 (or the payer computing device 110) may be configured to generate a random and unique passkey for the payment (e.g., via the payment request client application 158. In an exemplary embodiment, the passkey is known only to the payer and the payee in order to provide enhanced security for the payment.

At 204, the payer financial institution computer system 130 generates the payment code based on the payment request. As described above, the payment code may be generated as a token or other non-financial identifier that replaces sensitive payment account information or any other information received as part of the request. The payment code is intended to be used as a payment credential to initiate transfer of the payment amount to the payee from the payment account of the payer. For example, the payment code may be a graphical code that is scannable by a recipient POS device to read the payment code. The payment code may also be a sixteen-digit number that may be manually entered at a POS device and used in a manner similar to a check or credit card number to make a payment or a deposit.

Various information related to the payment, including the passkey, may be embedded within or otherwise associated with the payment code when the payment code is generated, such that the associated information is retrievable to validate the payee and process the payment. For instance, any information provided as part of the payment request may be “tokenized” (i.e., replaced by a unique identifier) or otherwise embedded within the payment code. The stored information may then be required at a point of redemption to validate the payee. In some embodiments, the payment code may be generated to include an expiration date or other life cycle information. The life cycle information may then be determined and applied by a recipient at the time of redemption (e.g., by de-tokenizing the payment code). For instance, if the payment code has expired, the recipient may decline to provide the requested value to the payee.

Prior to generating the payment code, the payer financial institution computer system 130 may authenticate the payer and/or the payee. For instance, the payer financial institution computer system 130 may authenticate the payer based on location information received or determined as part of the request (e.g., by comparing the determined location with an expected or known location of the payer). The payer financial institution computer system 130 may also compare other contextual information determined as part of the payment request with expected or known information to determine if the request for payment is fraudulent. For instance, the request may be determined fraudulent if the request is received from an unauthorized or unknown location, an unauthorized or unknown device, or for an unauthorized payment amount (e.g., over a threshold). The request may also be determined fraudulent based on the designated payer or payee, the timestamp, or based on any other information described herein. If the payer financial institution computer system 130 detects fraud, the system 130 may be configured to generate a false payment code and provide to the payer computing device 110.

At 206, the payer financial institution computer system 130 sends the payment code to the payer computing device 110. The payer computing device 110 may store the payment code until the payment code is delivered to the payee. The payer computing device 110 may store more than one payment code at any time in a mobile wallet application provided by the payer financial institution computer system 130, for instance.

At 208, the payer computing device 110 provides the payment code to the payee (e.g., the payee computing device 150). The payment code may be provided to the payee in person (e.g., via an exchange between the payer and the payee). The payment code may also be communicated to the payee electronically (e.g., via e-mail, text message, instant message, the payment request client application, etc.). For instance, the payment code may be stored by the payee in the payment request client application 158. In other embodiments, the payer financial institution computer system 130 may send the payment code directly to the payee (e.g., the payee computing device 150) upon generating the code. For instance, the payer financial institution computer system 130 may send the payment code directly to the payee via the payment request client application 158.

At 210, the payee presents the payment code for redemption at the recipient computer system 160. The payee may also provide any information required to validate the payee and/or the payment code at this time, including the passkey and any other information embedded within the payment code. Upon receiving the payment code, the recipient computer system 160 may also request additional information from the payee in order to validate the payee.

At 212, the recipient computer system 160 is configured to validate the payee based on the information embedded within the payment code. The payee is validated by matching any verification information stored within the payment code (e.g., the passkey) with information received from the payee. The recipient computer system 160 may be configured to de-tokenize the payment code in order to retrieve any information stored within the payment code. The recipient computer system 160 may also validate the payment code. The payment code may be validated based on information stored within the payment code, as well as any rules determined by any of the parties to the transaction. For instance, the recipient computer system 160 may validate the payment code by verifying that the payment code has not expired, or that the payment code has not been previously used.

Alternatively, the payee may be validated by the payer financial institution computer system 130. In such an embodiment, the recipient computer system 160 (at 214) may send the payment code and any information provided by the payee to the payer financial institution computer system 130. The recipient computer system 160 may identify the payer financial institution computer system 130 (and obtain contact information) based on information stored within the payment code. The payer financial institution computer system 130 validates the payee by matching the information provided by the payee with the verification information embedded within the payment code. The payer financial institution computer system 130 (at 216) provides an indication to the recipient computer system 160 that the payee has been validated. At 218, upon validating the payee, the recipient computer system 160 provides the payee with access to the payment amount. The payment amount may be transferred from the payer account at the payer financial institution computer system 130 to the payee by the recipient computer system 160. The payment network 170 may also be utilized to complete the payment once the payee is validated. The payer financial institution computer system 130 may then debit the payer account by the payment amount. If less than the full payment amount is transferred, the remaining funds may remain locked until all funds are transferred to the payee or the payment code expires.

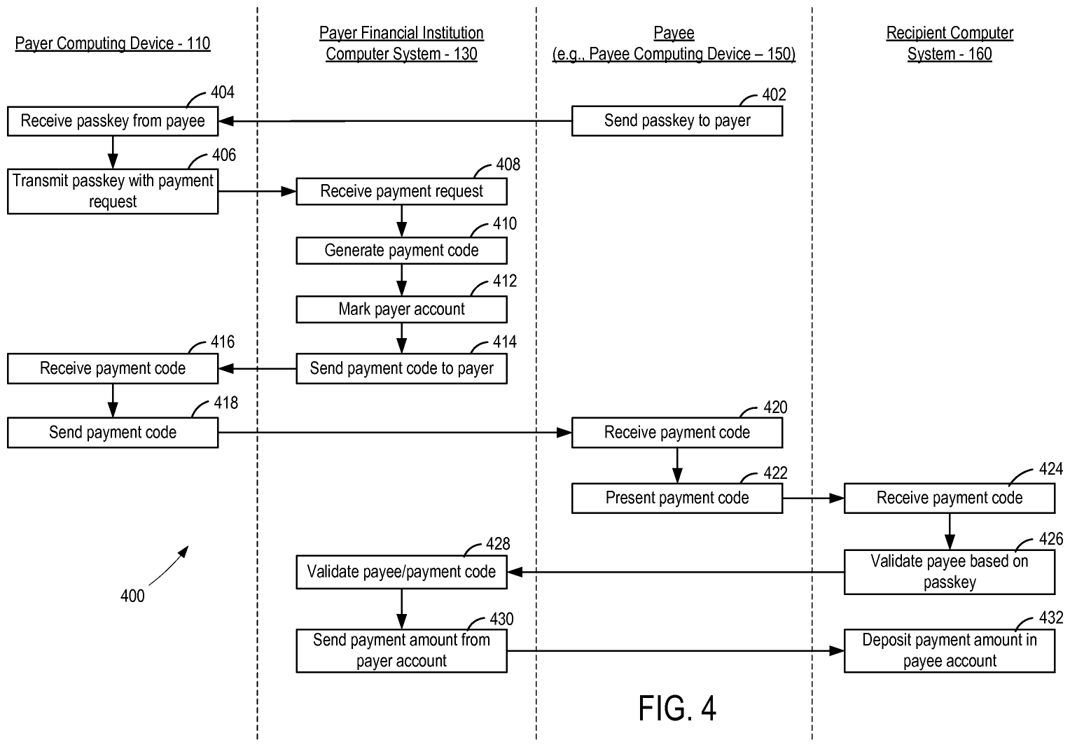

Referring now to FIG. 4, a process 400 is shown for facilitating a person-to-person payment using a payment code, according to an example embodiment. The process 400 may be performed using the payment processing system 100 shown in FIG. 1, including any of the payer computing device 110, the payer financial institution computer system 130, the payee computing device 150, and the recipient computer system 160, and all logic or other components of the systems and devices that are described in further detail herein.

Referring now to FIG. 4, a process 400 is shown for facilitating a payment from a payer to a payee using a payment code, according to an example embodiment. The process 400 includes generating a payment code based on a passkey and depositing the payment amount in a payee account upon validating the payee using the passkey. The process 400 may be performed using the payment processing system 100 shown in FIG. 1, including any of the payer computing device 110, the payer financial institution computer system 130, the payee computing device 150, and the recipient computer system 160 shown in FIG. 1, and all logic or other components of the systems and devices that are described in further detail herein.

At 402, the payee sends a passkey to the payer in order to initiate a payment from the payer to the payee. The payee may send the passkey electronically (e.g., from the payee computing device 150 to the payer computing device 110), or the payee may provide the passkey to the payer in person. The passkey may be determined by the payee. For instance, the passkey may be an alphanumeric key that is known to only the payee and the payer. The passkey may also be randomly generated by the payee computing device 150. At 404, the passkey is received by the payer.

At 406, the payer sends a payment request to the payer financial institution computer system 130 using the payer computing device 110. The payment request includes the passkey that was received from the payee. The payment request may also include a payment amount. The payment request may also include information related to the payee. For instance, the payment request may include identifying information for the payee, or other information intended to target or limit the payment to the payee. The payer may also be able to customize the payment code, including selecting a method by which the payment code is sent to the payer computing device 110, and whether the code is a graphic code or alphanumeric code. The payment request may be sent via the payment request client application 122. For example, the payment request may be transmitted to the payer financial institution computer system 130 via the user interface 300 shown in FIG. 3. At 408, the payer financial institution computer system 130 receives the payment request from the payer computing device 110.

At 410, the payer financial institution computer system 130 generates a payment code based on the payment request. The payer financial institution computer system 130 is configured to associate the passkey with the payment code. In an example embodiment, the payer financial institution computer system 130 embeds the passkey within the payment code. The payer financial institution computer system 130 may also associate the payment amount, as well as any other information received as part of the payment request, with the payment code. The information to be associated with the payment code may be specified by the payer when requesting the payment. As described in further detail above, the payment code may be an alphanumeric code, a graphic code (e.g., barcode), or another type of code that is useable by the payee to access the payment amount.

At 412, the payer financial institution computer system 130 places a marker (e.g., notation, recordation, etc.) on the payer account according to the payment request. For instance, the payer financial institution computer system 130 may restrict access to specified funds (i.e., the payment amount) within the payer account for a specified period of time (e.g., 3 days, 1 week, etc.) based on the marker. The held funds are intended to guarantee that the payment is available to the payee for the specified period of time. The marker is also intended to indicate to the payer that there are outstanding payments that have yet to be completed, so that the payer is aware that the payment has not been processed. The marker may also provide an indication to the recipient computer system 160 that the funds are available and earmarked. The marker may also be utilized by a third party payment processor (e.g., a card network or other payment system). In some embodiments, the marker may be required to validate the payee and/or the payment code.

At 414, the payer financial institution computer system 130 sends the payment code to the payer computing device 110. For instance, the payment code may be sent via the payment request client application 122. The payment code may also be sent using any other type of messaging system, including text message, e-mail, instant message, alerts, and the like. At 416, the payment code is received by the payer computing device 110.

At 418, the payment code is sent to the payee. The payment code may be sent from the payer computing device 110 to the payee computing device 150, or the payment code may be provided person-to-person. At 420, the payment code is received by the payee. At 422, the payment code is presented for redemption at the recipient computer system 160. In this embodiment, the recipient computer system 160 is a financial institution providing one or more accounts held by the payee. The payee may present the payment code to the payee in order to deposit the payment amount into an account held by the payee. The payee may also provide any required verification information at this time. For instance, the payee may provide the passkey to the recipient computer system 160 in order to validate the payee and/or the payment code. The verification information (e.g., the passkey) may be requested by the recipient computer system 160 based on the information stored within the payment code.

At 424, the payment code and verification information (e.g., the passkey) are received by the recipient computer system 160. The recipient computer system 160 may be configured to interpret (e.g., de-tokenize, read, de-code, etc.) the payment code to determine any information that is embedded within the payment code. The recipient computer system 160 may then request the verification information from the payee. For instance, the recipient computer system 160 may include a scanner or other POS device configured to read and interpret the payment code. The payee may also enter an alphanumeric payment code at an ATM or other POS device of the payee financial institution. In an example embodiment, the recipient computer system 160 determines that a passkey is required based on the payment code, then requests the passkey from the payee.

At 426, the recipient computer system 160 validates the payee based on the information provided by the payee and the verification information stored within the payment code. For instance, the recipient computer system 160 may send the payment code and the verification information to the payer financial institution computer system 130 to request validation of the payee. The recipient computer system 160 may identify the financial institution computer system 130 based on the payment code. At 428, the payer financial institution computer system 130 validates the payee by matching verification information stored in the payment code with information received from the payee. In other embodiments, the recipient computer system 160 may validate the payee by matching input received from the payee with payee information stored at the payee financial institution. At 430, upon validation of the payment code, the payer financial institution computer system 130 debits the payment amount, or a lesser amount requested by the payee, from the payment account of the payer. The payer financial institution computer system 130 sends the requested amount to the recipient computer system 160. Any portion of the payment amount remaining in the payer account remains locked by the payer financial institution computer system 130 until the full payment amount is provided to the payee or the payment code is expired. At 432, the recipient computer system 160 receives the payment amount (or a lesser amount) from the payer financial institution computer system 130 and deposits the payment amount in an account of the payee.

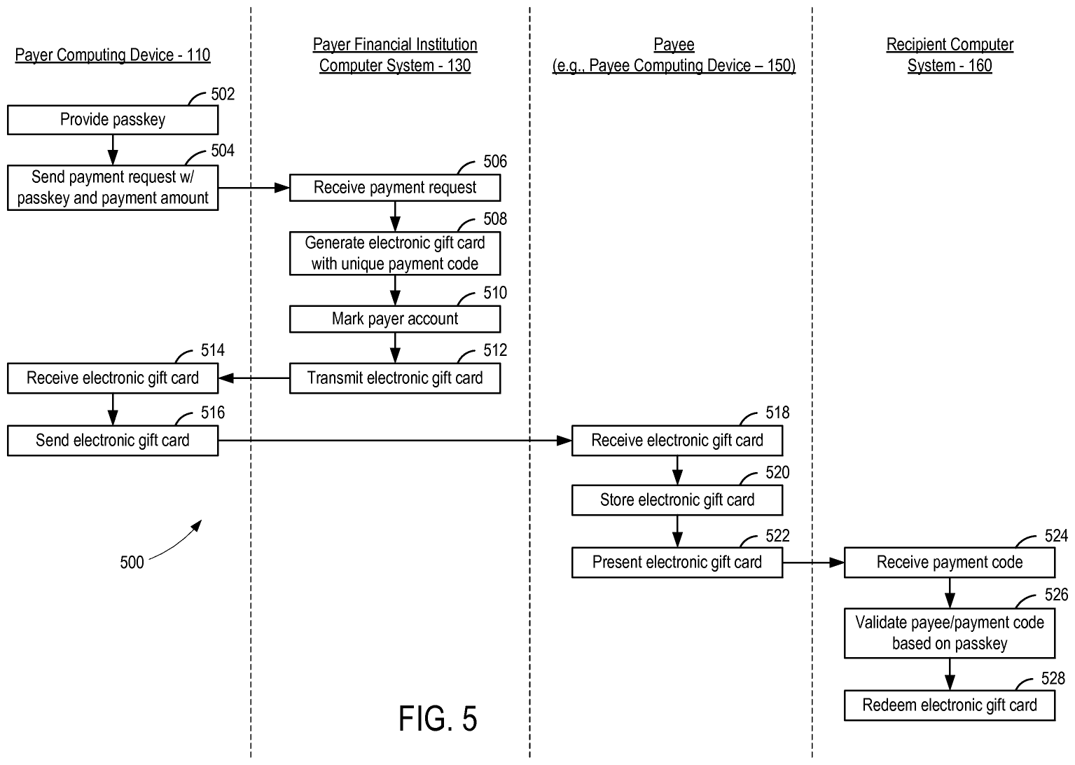

Referring now to FIG. 5, a process 500 is shown for facilitating a payment from a payer to a payee using a payment code, according to another example embodiment. The process 500 may be performed using the payment processing system 100 shown in FIG. 1, including all logic or other components of the systems and devices that are described in further detail herein. The process 500 may include generating an electronic gift card for the payee based on a payment request received from the payer.

At 502, the payer determines a passkey for a payment from the payer to a payee. The passkey may be received from the payee. For instance, the passkey may be provided by the payee in response to a request from the payer. In one embodiment, the payer is attending a an event hosted by the payee (e.g., a birthday party, an anniversary party, etc.) and requests the passkey in order to send a gift card to the payee. In this embodiment, the passkey may be specific to the event and/or the payee in order to enhance the security of the payment code. An example of such a passkey is the phrase “Sam 50^{th} birthday September 18.” In this example, the passkey is unique to the event (i.e., the payee's 50^{th} birthday party), as well as the payee (i.e., the birth date of the payee). In other embodiments, the payee could provide additional personal information that is not widely known to enhance security of the payment code, including a driver's license number, date of birth, or another unique passkey. The passkey may also be randomly generated (e.g., by device 110, device 150, etc.).

At 504, the payer computing device 110 sends a payment request to the payer financial institution computer system 130. The payment request includes specified verification information (e.g., the passkey) and a payment amount. The payment request also includes a selection of an electronic cash gift card that is payable to the payee as the form of payment. The payer may specify requirements or preferences relating to the gift card as part of the payment request. In an example embodiment, the payer specifies in the payment request that the electronic gift card may only be redeemed by the recipient computer system 160. For instance, the payer may be a parent of a college student. The parent (i.e., the payer) may submit a payment request for an electronic gift card that is redeemable only by the college student (i.e., a specified payee) at the campus bookstore (i.e., the recipient computer system 160). The payment request may also be configurable to restrict redemption of the gift card to a specific location associated with the recipient computer system 160. The payment request may also be configurable to include an expiration date for the payment, such that the gift card (i.e., the payment code) is invalidated after a specified period of time (e.g., six months). The payer may also specify a particular design for the electronic gift card as part of the payment request. At 506, the payment request is received by the payer financial institution computer system 130 from the payer computing device 110.

At 508, the payer financial institution computer system 130 generates the electronic gift card, including the payment code. The payment code may be unique to the payment. The payment code may be generated to include the passkey and any other verification information. The payment code may also include any other redemption requirements provided by the payer. The electronic gift card may be configured to be stored by the payer and/or the payee. For instance, the electronic gift card may be generated based on the payee's storage device (e.g., mobile phone, tablet, watch, etc.). The payer may provide usage information for the payee when sending the payment request, such that the electronic gift card is generated in a format that is useable by the payee to access the associated funds. In an example embodiment, the electronic gift card is useable like a debit card. For instance, the electronic gift card may be used to make a payment to a third party (e.g., a merchant or service provider) using funds from the payer account. At 510, the payer financial institution computer system 130 records the payment at the payer account, which may include placing a hold on a portion of the funds in the account until the payment is completed.

At 512, the payer financial institution computer system 130 transmits the electronic gift card (i.e., the payment code) to the payer computing device 110. The electronic gift card may be sent via the payment request client application 122. The electronic gift card may also be sent using any other type of electronic message, including e-mail, text message, direct message, instant message, and the like. At 514, the electronic gift card is received by the payer computing device 110. The electronic gift card may be stored on the payer computing device 110 (e.g., using the payment request client application 122). The stored electronic gift card may include a “card” design that is displayable on the payer computing device 110.

At 516, the payer computing device 110 sends the electronic gift card to the payee computing device 150. The electronic gift card may be sent with a message that includes information related to the electronic gift card, including any inherent requirements or limits. In an example embodiment, the electronic gift card specifies that the card may be redeemed only at the recipient computer system 160 by the payee. The electronic gift card may be sent using a client application (e.g., payment request client application) that is running on both the payer computing device 110 and the payee computing device 150. In other embodiments, the electronic gift card may be transmitted using another type of electronic message. At 518, the electronic gift card is received by the payee computing device 150. At 520, the electronic gift card is stored on the payee computing device 150 (e.g., within the payment request client application 158).

At 522, the payee presents the electronic gift card (i.e., the payment code) for redemption at the recipient computer system 160. For instance, the payment code may be presented via a display on the payee computing device 150. The payment code may also be provided manually (e.g., as an alphanumeric code provided in person). At 524, the recipient computer system 160 receives the payment code from the payee. For instance, the payment code may be read (e.g., scanned) by a POS device of the recipient computer system 160. The recipient computer system 160 may also receive any required verification information. At 526, the recipient computer system 160 validates the payee and/or the payment code based on the verification information (e.g., the passkey) associated with the payment code. The recipient computer system 160 may validate the payee by matching any verification information stored within the payment code with information provided by the payee. Validating the payee may also include verifying that the electronic gift card was presented for redemption at the recipient computer system 160 (i.e., the recipient location specified by the payer). The payee may also be validated by the payer financial institution computer system 130, as is described herein in relation to the process 400.

At 528, upon validation of the payee, the recipient computer system 160 redeems the electronic gift card and enables the payee to use the value (i.e., the payment amount) stored on the gift card. The value is provided to the recipient computer system 160 from the payer financial institution computer system 130 (i.e., from the payer account). In one embodiment, the recipient computer system 160 is a merchant. In this embodiment, the payee may present the electronic gift card as payment for goods or services. Upon validating the payee based on the payment code, the merchant may redeem the electronic gift card to receive at least a portion of the payment amount in exchange for goods or services. In another embodiment, the recipient computer system 160 is a financial institution of the payee. In this embodiment, the payee may present the electronic gift card in order to receive the payment amount in the form of a deposit or direct payment. In another embodiment, the recipient computer system 160 is a money exchange or another financial institution to which the payee does not belong (i.e., does not hold accounts). In this embodiment, the payee may present the electronic gift card to the recipient computer system 160 in order to receive the cash amount.

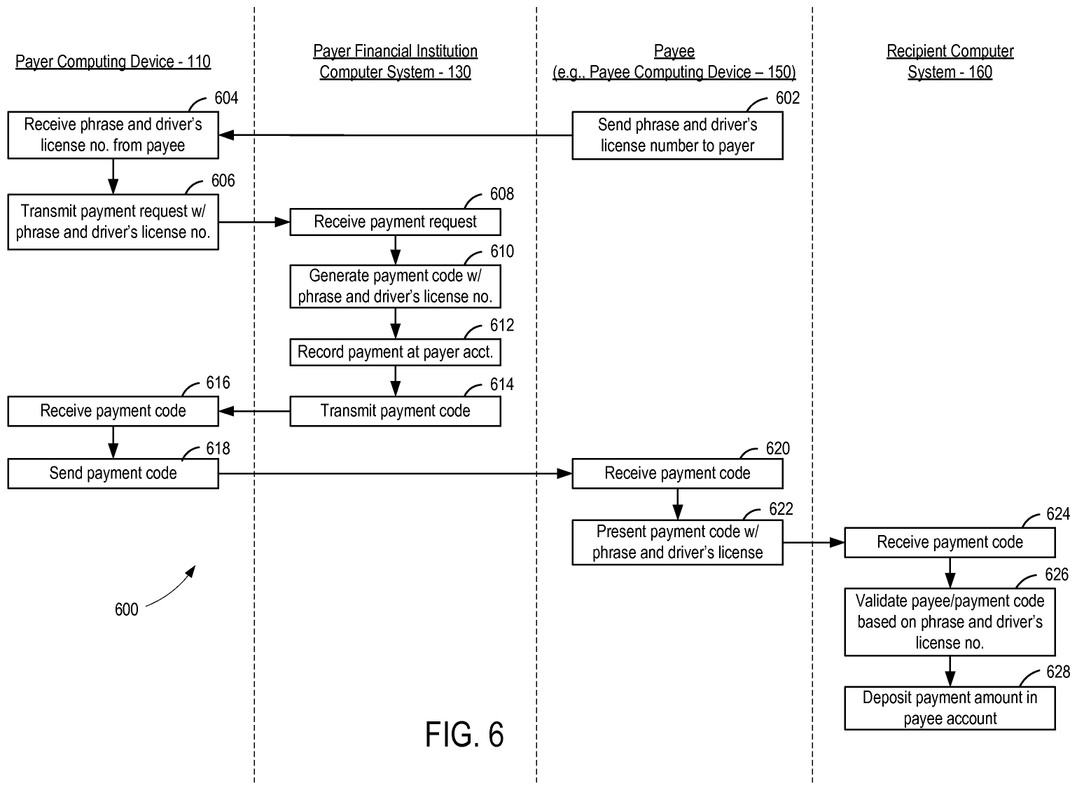

Referring now to FIG. 6, a process 600 is shown for facilitating a payment from a payer to a payee using a payment code, according to an example embodiment. The process 600 may be performed using the payment processing system 100 shown in FIG. 1, including all logic or other components of the systems and devices that are described in further detail herein. The process 600 may include requiring additional verification information from the payee in order to redeem the payment code.

At 602 of the process 600, the payee sends information to the payer to initiate a payment from the payer to the payee. The information includes a first passkey. The first passkey may be an alphanumeric phrase that is determined by the payee or randomly generated. The information also includes a second passkey (i.e., a secondary factor). The second passkey is intended to provide enhanced verification for the payment. The second passkey may be unique to the payee and/or the payment. For instance, the second passkey may include a driver's license number of the payee, an image of the payee driver's license, an image of the payee, biometric data of the payee, or any combination of the above. The second passkey may be required by the payer financial institution computer system 130 for enhanced security payments. For instance, a second passkey may be required to generate a payment code for payments over a predetermined threshold (e.g., $1,000), with additional passkeys or verification information required at various escalating intervals (e.g., third passkey at $10,000, fourth passkey at $100,000, etc.). The second passkey may also be required when theft or fraud is suspected. For instance, the payer or the payee may designate (e.g., using the client application 122 or 158) that the second passkey is required to redeem the payment code if the payment code becomes known to another party. At 604, the passkeys are received by the payer computing device 110.

At 606, the payer device transmits a payment request to the payer financial institution computer system 130. The payment request includes at least a payment amount, and any passkeys. At 608, the payer financial institution computer system 130 receives the payment request. In some embodiments, any additional passkeys (e.g., the second passkey) are requested by the payer financial institution computer system 130. For instance, the payer financial institution computer system 130 may request an additional passkey when the payment amount exceeds the predetermined threshold.

At 610, the payer financial institution computer system 130 generates the payment code, including embedding the passkeys within the payment code. At 612, the payer financial institution computer system 130 marks the payer account with the payment amount. At 614, the payer financial institution computer system 130 transmits the payment code to the payer computing device 110. At 616, the payer computing device 110 receives the payment code.

At 618, the payer computing device 110 sends the payment code to the payee. At 620, the payee receives the payment code from the payer computing device 110. At 622, the payee presents the payment code to the recipient computer system 160 for redemption. The payee also provides any passkeys to the recipient computer system 160. At 624, the recipient computer system 160 receives the payment code from the payee. The recipient computer system 160 may request any information from the payee that is required to validate the payment code, including any embedded passkeys. For instance, if the second passkey is an image of the payee's driver's license or the payee's driver's license number, the recipient computer system 160 may also request that the payee provide the driver's license to validate both the driver's license information and the identity of the payee. At 626, the recipient computer system 160 validates the payee. The payee and/or the payment code may be validated by matching the passkeys stored within the payment code to the information provided by the payee at redemption. The payee may also be validated by the payer financial institution computer system 130, or in cooperation, with the payer financial institution computer system 130, as is otherwise described herein. At 628, upon validation of the payee, the recipient computer system 160 provides the payment amount to the payee. For instance, the recipient computer system 160 may deposit the payment amount in an account held by the payee. The payment amount may be transferred to the payee from the payer financial institution computer system 130 (i.e., from the payer account) upon validation of the payee and/or the payment code.

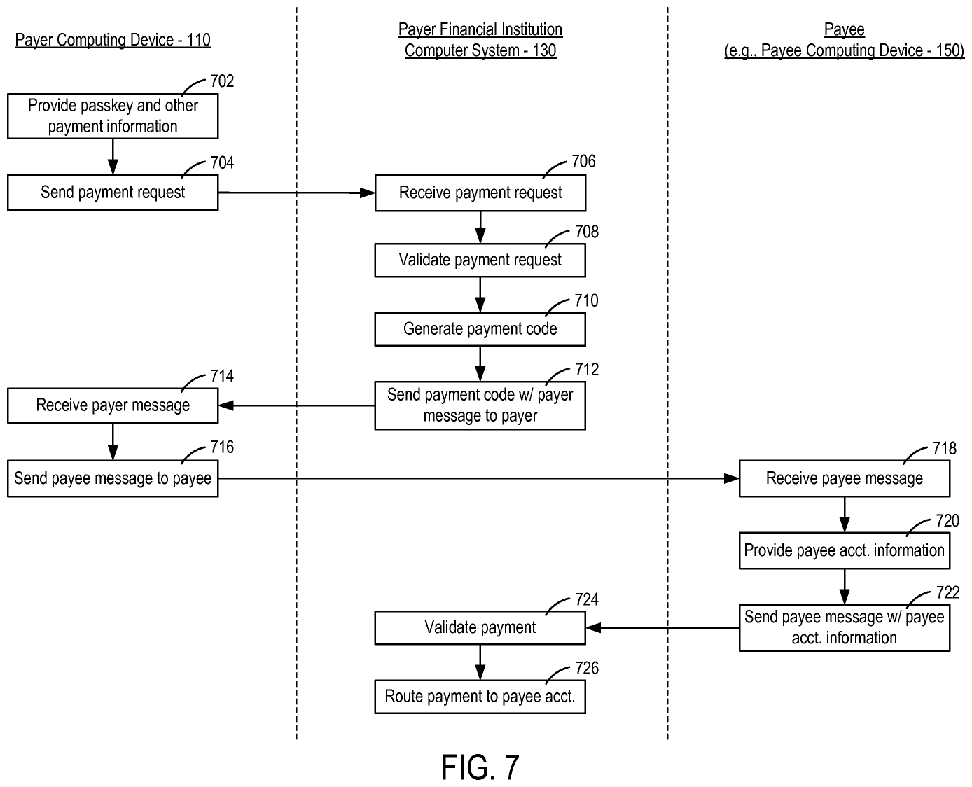

Referring now to FIG. 7, a process 700 is shown for facilitating a payment from a payer to a payee using a payment code, according to an example embodiment. The process 700 may be performed using the payment processing system 100 shown in FIG. 1, including all logic or other components of the systems and devices that are described in further detail herein. The process 700 includes providing a message to the payer in response to a payment request. The message may be forwarded to the payee by the payer. The message may be presented by the payee, along with additional payee information, to receive the associated payment.

At 702, the payer initiates a payment request by providing payment information. The payment information is provided using the payment request client application 122 stored on the payer computing device 110. The payment information includes a passkey. The passkey may be provided by the payee. The passkey may also be randomly generated (e.g., by the client application 122). The payment information may also include a second passkey, which may include information unique to the payee. At 704, the payer computing device 110 sends the payment request to the payer financial institution computer system 130 using the client application 122. In an example embodiment, the payment request includes the passkey(s), contact information for the payee, a payment amount, and payer account information. The payment request may also include identifying information for the payer computing device 110. At 706, the payer financial institution computer system 130 receives the payment request.

At 708, the payer financial institution computer system 130 validates the payment request, which may include validating the payer, the payer computing device 110, and the payer account. The payment request may be validated based on account information for the payer stored in the payer financial institution computer system 130. The payment request may also be validated based on a location of the payer computing device 130.

At 710, the payer financial institution computer system 130 generates a payment code. The payment code may be generated using the payment request client application 122, the contents of which may be stored on a server of the payer financial institution computer system 130. When the payment code is generated, the payer financial institution computer system 130 may link the payment code to the payment request, including the specified payer account (i.e., the payment account), the payee contact information, the payment amount, and the passkey(s). For instance, any of this information may be embedded within the payment code when generated. The payer financial institution computer system 130 may also “lock” the payment amount in the payer account so that the funds are not available to the payer until the payment code expires.

At 712, the payer financial institution computer system 130 sends a message to the payer (i.e., a payer message). The payer message may be generated by the payer financial institution computer system 130. The payer message includes the payment code. The payer message may also include a message to be forwarded to the payee (i.e., a payee message). The payee message is intended to be used by the payee to redeem the payment code and access the associated funds. At 714, the payer computing device 110 receives the payer message, including the payee message.

At 716, the payer computing device 110 sends the payee message to the payee (e.g., the payee computing device 150). The payee message may be sent using any type of electronic messaging convention or system. At 718, the payee receives the payee message. The payee message includes the payment code. The payee message may also include other information related to the payment, including the passkey(s), the payment amount, and contact information for the payer financial institution computer system 130. The payee message may also include an input for the payee to provide additional information in order to redeem the payment code. For instance, the payee may be required to provide payment routing information (e.g., payment method, account information, etc.). The payee message may include instructions for the payee to redeem the payment code and access the associated funds.

At 720, the payee provides the required payee information. The payee information may include account information required by the payer financial institution computer system 130 to transfer the funds to the payee account. The payee information may also include any verification information that is embedded within the payment code and required to validate the payee. At 722, the payee sends the payee message, including the payee account information, to the payer financial institution computer system 130. The payee may utilize contact information for the payee financial institution computer system 130 that is included within the payee message. At 724, the payer financial institution computer system 130 receives the payee message and validates the payment based on the information received from the payee. For instance, the payer financial institution computer system 130 may validate the payment by verifying that the verification information provided by the payee matches the verification information originally provided by the payer (i.e., in the payment request). At 726, upon validating the payment, the payer financial institution computer system 130 routes the payment from the payer account to the payee account. The payee account may be specified by the payee. The payer financial institution computer system 130 may also send a confirmation message to the payee computing device 110 upon completing the payment.

The payee may alternatively receive the payment by providing the payment code to the recipient computer system 160. The payee may determine the payment code based on the payee message. In one embodiment, the payee provides the payment code and any verification information to the payer financial institution computer system 130 via a branch location or ATM of the payer financial institution. The payer financial institution computer system 130 may then validate the payee and dispense cash to the payee via the teller or ATM. Upon redemption by the payee, the payment amount is debited from the designated account of the payer by the payer financial institution computer system 130. In another embodiment, the payee provides the payment code and any verification information to the payer financial institution computer system 130 using a website or application of the payer financial institution. Once the payee is validated, the payee may provide payment and routing information to the payer financial institution computer system 130. Based on the payee account information, the payer financial institution computer system 130 may credit the specified account of the payee and debit the payment amount from the account of the payer.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1-14. (Canceled)

15. A computer-implemented method performed by one or more processors of a payer financial institution computer system, the method comprising:
receiving, by the one or more processors of the payer financial institution computer system, a request from a computing device of a payer to make a payment to a payee from a payment account of a payer, wherein the request includes a passkey that is unique to the payee, a payment amount, a selection of an electronic gift card, a design for the electronic gift card, usage information of a computing device of the payee, and a required recipient;
generating, by the one or more processors of the payer financial institution computer system, based at least in part on the request, an electronic gift card that includes the passkey and that can only be redeemed at a recipient computer system by the computing device of the payee;
sending, by the one or more processors of the payer financial institution computer system, via a payment request client application, the electronic gift card to the payer device;
receiving, by the one or more processors of the payer financial institution computer system, the passkey from the recipient computing system for an electronic transaction using the electronic gift card; and
validating, by the one or more processors of the payer financial institution computer system, the passkey for the electronic transaction.

16. (canceled)

17. The method of claim 15,
wherein the payee is validated at least in part based on additional verification information provided by the payee.

18. The method of claim 15,
wherein the request to make a payment includes a specific location of the recipient computer system;
wherein generating the electronic gift card further comprises generating the electronic gift card to include the specific location of the recipient computer system; and
wherein validating the passkey further comprises verifying that the electronic gift card was presented for redemption at the specific location of the recipient computer system.

19. (canceled)

20. (canceled)

21. The method of claim 15, wherein the electronic gift card expires after an expiration date, and wherein generating the electronic gift card includes embedding the expiration date within the electronic gift card.

22-28. (Canceled)

29. The method of claim 15, wherein the unique payment code comprises personal information provided by the payee.

30. The method of claim 15, wherein the request from the computing device of the payer to make the payment to the payee restricts redemption of the electronic gift card to a specified location of the required recipient.

31-41. (Canceled)

42. The method of claim 15, wherein the passkey comprises a unique identifier that represents the payee.

43. The method of claim 42, wherein the passkey further comprises at least one of a phrase provided by the payee, a driver's license number of the payee, an image of the payee, and biometric data related to the payee.

44-46. (Canceled)

47. The method of claim 15, wherein the computing device of the payer is different from the computing device of the payee.
